(19) United States
(12) Patent Application Publication
(10) Pub. No.: US 2026/0067283 A1
(43) Pub. Date: Mar. 5, 2026

(54) SECURE CROSS-CLOUD RESOURCE ACCESS WITH SINGLE USER IDENTITY

(71) Applicant: Microsoft Technology Licensing, LLC, Redmond, WA (US)

(72) Inventors: Suyin LIU, Suzhou (CN); Na LI, Bellevue, WA (US); Jun SHI, Redmond, WA (US); Yizhong WU, Shanghai (CN); Anthony David CHECKAL, Redmond, WA (US); Binbin WU, Suzhou (CN); Jie GUO, Suzhou (CN); Jingjing HAN, Suzhou (CN)

(73) Assignee: Microsoft Technology Licensing, LLC, Redmond, WA (US)

(21) Appl. No.: 19/108,320

(22) PCT Filed: Sep. 30, 2022
(86) PCT No.: PCT/CN2022/123572

§ 371 Date: Mar. 3, 2025

(51) Int. Cl. H04L 9/40

(52) U.S. Cl. CPC H04L 63/102; H04L 63/083; H04L 63/105

(57) ABSTRACT

Systems and methods are provided for a secure cross-cloud resource access based on user identity. In particular, the system includes a plurality of clouds where a first cloud enforces more restrictive access than a second cloud. In particular, an end user of the second cloud also uses user identity stored in the less restrictive first cloud. The system includes authenticating and authorizing tokens associated with an administrator of the first tenant in the first cloud and the second tenant in the second cloud. The onboarding establishes a two-way trust between the two tenants across the first and second clouds. Once established, operating an application service and accessing data resources in the second cloud is accomplished by logging into the first cloud and leverage the two-way trust to remotely launch application services in the second cloud using a tenant graph and a location service in the first cloud.

### BACKGROUND

As cloud services over a network have become more commonplace, organizations are increasingly using multiple clouds. Respective clouds vary in security protections associated with users and data resources, ranging from public clouds with lower security protections to private clouds having more security protections. One similarity between different clouds is that they all manage distinct user identities. In order to access data or applications from a particular cloud, users traditionally must log in to that particular cloud separately.

It is with respect to these and other general considerations that the aspects disclosed herein have been made. In addition, although relatively specific problems may be discussed, it should be understood that the examples should not be limited to solving the specific problems identified in the background or elsewhere in this disclosure.

### SUMMARY

Aspects of the present disclosure relate to systems and methods for secure cross-cloud resource mapping between clouds having different security requirements, e.g., a public cloud and a private cloud. Upon receiving a request for establishing a two-way trust relationship, also referred to as a “cross-cloud relationship” or a “mutual trust relationship”, between a first tenant of a public cloud and a second tenant of a private cloud based on a cross-cloud mapping, embodiments authenticate and authorize the cross-cloud mapping based on user credentials associated with administrators of the public cloud and the private cloud. The authorization process further includes an evaluation of permission information, to determine if the tenant on the public cloud has adequate permission to access the service application (e.g., a virtual machine running a virtual desktop) in the second tenant in the private cloud. Once the cross-cloud mapping is established and the private cloud is on-board the public cloud for secure access, initiating the execution of service applications in the private cloud requires a user identity of the administrator of the public cloud. A two-way trust established between the first tenant of the public cloud and the second tenant of the private cloud enables application services to be operated in the private cloud based on a user identity for an end user of the tenant in the public cloud. That is, an end user of the private cloud who also has a user identity managed in the public cloud logs into the first tenant of the public cloud. When the end user of the private cloud needs to run an application service for accessing data resources in the private cloud, the end user further logs into the private cloud and uses a virtual desktop rendered by an application service being executed on a virtual machine executed in the second tenant of the private cloud.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system of mapping across clouds for secure cross-cloud resource access in accordance with aspects of the present disclosure.

FIG. 2 illustrates an overview of an example system of using clouds for secure cross-cloud resource access in accordance with aspects of the present disclosure.

FIG. 3 illustrates an overview of an example system of an end user accessing secure cross-cloud resources in accordance with aspects of the present disclosure.

FIG. 4 illustrates an example graphical user interfaces in accordance with aspects of the present disclosure.

FIG. 5A illustrates an example of methods for establishing a secure cross-cloud mapping and accessing resources in a private cloud in accordance with aspects of the present disclosure.

FIG. 5B illustrates an example of methods of mapping tenants across clouds for secure cross-cloud resource access in accordance with aspects of the present disclosure.

FIG. 5C illustrates an example of methods of using services and data resources across clouds for secure cross-cloud resource access in accordance with aspects of the present disclosure.

FIG. 5D illustrates an example of methods of an end user accessing secure cross-cloud resources in accordance with aspects of the present disclosure.

FIG. 5E illustrates an example of methods of offboarding a tenant for secure cross-cloud resource access in accordance with aspects of the present disclosure.

FIG. 6 illustrates an example of a computing device with which aspects of the present disclosure may be practiced.

FIG. 7 is a simplified block diagram of a computing device with which aspects of the present disclosure may be practiced.

### DETAILED DESCRIPTION

Organizations around the world are increasingly moving to the cloud. As the adoption of cloud services grows, the complexity of the services and solutions in the cloud also grows, creating scenarios where a user must access more than one cloud, each of which varies in level of security and types of data resources stored. In some cases, services need to operate transparently across multiple clouds. The multi-cloud configuration has become a more complex and challenging security environment. Requiring users to use multiple user identities for accessing respective clouds increases operational burden upon the user and increases the risk of operational errors and compromises in security.

The complexities associated with accessing resources stored across clouds include the presence of distinct user identities for different clouds, remotely using application services that execute in another cloud, and remotely accessing data resources stored in another cloud. Traditional technologies include federating multiple instances of user directories into a single instance. Issues still remain in federating user directories because credentials for enabling execution of application services (e.g., a virtual machine executing a virtual desktop) may need to be authenticated and authorized separately from an access to data resources. The resulting single instance of the federated system may be complicated to set up and configure. Federating multiple instances of user directories may also lack established trust between clouds and thus may be unsuitable for a cross-cloud scenario where two clouds (e.g., a public cloud and a private cloud) have different security boundaries. Another traditional technology includes sharing applications and services of a tenant with guest users from other tenant(s). The sharing of applications and services often includes sending an explicit invitation and establishing a redemption process to be followed by individual guest users. Such traditional technology for accommodating guest users still lacks simplicity of usability for users who regularly use multiple clouds to execute service applications and to access data resources in the respective clouds.

As discussed in more detail below, embodiments described herein relate to systems and methods that enable users to access services associated with a private cloud using a single user identity to securely span from a public cloud to the private cloud. The disclosed technology is directed to allowing a user to continue using the user's user identity stored in the public cloud while having secure access to application services and data resources in the more restricted private cloud. In aspects, the disclosure creates and maintains a relationship between the public cloud and the private cloud by authenticating and authorizing administrator identities for both clouds and permission (e.g., a software license) for executing service applications in the private cloud. Once authenticated, the disclosed technology further maintains a mapping of a tenant in the private cloud to a tenant in the public cloud. The mapping of the tenant in the public cloud and tenant in the private cloud enables system administrators of the respective clouds to set up and configure the execution of service applications in respective clouds, while enabling end users of the private cloud tenant to access private cloud service applications through the public cloud.

In aspects, the disclosed technology leverages tokens associated with user directories that store user identities. Each token includes a variety of information associated with user identity, including a tenant identifier, an application identifier, and one or more roles associated with the administrator of the tenant of the cloud. Use of the token enables authentication and authorization of the administrator in order to create a mapping between tenants of different clouds and establish a two-way trust relationship.

Various aspects of the disclosure are described more fully below with reference to the accompanying drawings, which form a part hereof, and which show specific example aspects. However, different aspects of the disclosure may be implemented in many different ways and should not be construed as limited to the aspects set forth herein; rather, these aspects are provided so that this disclosure will be thorough, complete, and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

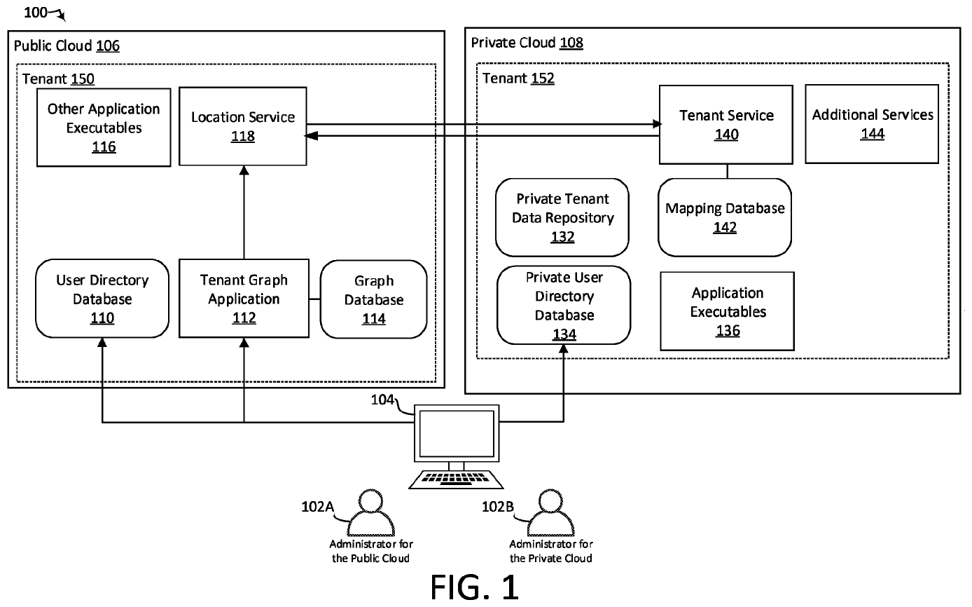

FIG. 1 illustrates an overview of an example system of mapping across clouds (e.g., onboarding of a cloud) for secure cross-cloud resource access in accordance with aspects of the present disclosure. A system 100 includes a client device 104, the public cloud 106, and the private cloud 108. In examples, the respective clouds may include one or more tenants. Each tenant includes one or more services. Each service includes one or more application executables. In examples, the public cloud 106 is less restrictive than the private cloud 108 in authenticating and authorizing execution of applications and access to data repositories. The public cloud 106 and the private cloud 108 are distinct clouds and manage distinct sets of user identities for end users. For simplicity, as shown, the public cloud 106 and private cloud 108 each have only one associated tenant, i.e., a tenant 150 in the public cloud 106 and a tenant 152 in the private cloud 108. The tenants are different and typically do not have a prior relationship, i.e., prior to the onboarding discussed herein. Also, those skilled in the art will appreciate that while only one tenant is shown in each cloud, the clouds may contain other tenants.

In examples, the system 100 performs onboarding a tenant of the private cloud 108 in the public cloud 106, wherein the onboarding generates a two-way trust relationship between the tenants. The onboarding includes mapping the tenant in the private cloud 108 to a tenant in the public cloud 106, which process will be described in more detail below. Once the tenant mapping is created, the tenant mapping enables an end user of the tenant of the public cloud 106 to use a virtual machine via a virtual desktop associated with tenant of the private cloud 108 to access service applications and data resources in the private cloud 108.

The public cloud 106 includes user directory database 110, tenant graph application 112, graph database 114, other application executables 116, and location service 118. The user directory database 110 stores and maintains user identities of end users associated with the public cloud 106. The tenant graph application 112 represents an executable that maintains a graph (not shown) wherein the graph describes relationships among tenants and clouds. The tenant graph application 112 connects to a graph database 114 that stores the graph. The other application executables 116 include other applications, e.g., third party applications, available for execution in the public cloud 106. The location service 118 is used in some embodiments of the present disclosure to identify a location of a remote service in another tenant of another cloud for connection to the public cloud 106 as described below.

The private cloud 108 includes private tenant data repository 132, private user directory database 134, application executables 136, a tenant service 140, a mapping database 142, and additional services 144. The private tenant data repository 132 stores data resources in the private cloud 108. The private user directory database 134 stores and maintains user identities of end users associated with the private cloud 108. The private tenant data repository 132 enforces access controls for users accessing the data resources according to the user identities of end users associated with the private cloud 108. The application executables 136 represent services applications to be executed in the private cloud 108.

The tenant service 140 executes and maintains an application service in a tenant in the private cloud 108. The tenant service 140 further maintains a mapping between tenants in the public cloud 106 and tenants in the private cloud 108. The mapping database 142 stores data associated with mapping the tenant with another tenant in the public cloud 106. The additional services 144 relate to other services in the private cloud 108 that are in addition to the application executables 136 and the tenant service 140.

With respect to the onboarding aspect of the present disclosure, the client device 104 receives a combination of a user identity of an administrator 102A for the public cloud 106 and a user identity of the administrator 102B for the private cloud 108. The client device 104 communicates with the user directory database 110 of the public cloud 106 for authenticating the user identity of the administrator 102A for the public cloud 106. Similarly, the client device 104 communicates with the private user directory database 134 in the private cloud 108 for authenticating the user identity of the administrator 102B for the private cloud 108.

Upon authenticating the user identity of the administrator 102A for the public cloud 106, the client device 104 requests the tenant graph application 112 in the public cloud 106 to identify a tenant in the private cloud 108 and establish a mutual trust relationship, i.e., a two-way trust relationship between the tenant in the public cloud 106 and the tenant in the private cloud 108. The request includes a name of the tenant in the private cloud 108 and security credentials associated with the user identity of the administrator 102B of the private cloud 108. The tenant graph application 112 retrieves tenant information from the graph database 114. The tenant graph application 112 requests the location service 118 to connect to the identified tenant in the private cloud 108.

The location service 118 connects to the tenant service 140 of the private cloud 108. The location service 118 identifies a location of the tenant in the private cloud 108 and sends (e.g., redirects) a request establishing a two-way trust relationship between the tenant of the public cloud 106 and the tenant of the private cloud 108. In an embodiment, the location service 118 authenticates and authorizes the user identity of the administrator 102A for the public cloud 106. Upon a successful completion of the authentication and authorization, the location service 118 sends the request to the tenant service 140 of the private cloud 108. The request includes user credentials associated with the user identity of the administrator 102A of the public cloud 106 and the user identity of the administrator 102B of the private cloud 108. The request further specifies an application service as an executable resource to be remotely accessed from the public cloud 106.

The tenant service 140 in the private cloud 108 receives the request for establishing the two-way trust relationship between the tenant in the private cloud 108 and the tenant in the public cloud 106. The tenant service 140 performs authentication and authorization using the received user credentials. During authentication, the tenant service 140 validates both of the tokens associated with the respective administrators 102A and 102B. In aspects, the tenant service 140 confirms whether the tenant in the public cloud 106 has a valid license or permission (e.g., an authorization) for executing a service application. For authorizing, the tenant service 140 validates both tokens, identifiers associated with application services to be executed in the private cloud 108, and the roles of both tenants (e.g., the tenant in the public cloud 106 and the tenant in the private cloud 108) to enable a more fine-tuned authorization of specific resource and/or service access. The mapping database 142 stores the mapping between the tenant in the public cloud 106 and the tenant in the private cloud 108.

As detailed above, the system 100 establishes a mapping between a tenant in the public cloud 106 and another tenant in the private cloud 108. Authorizing and authenticating associated with establishing the mapping are based on a pair of user identities associated with the administrator 102A of the public cloud 106 and the administrator 102B of the private cloud 108. Once the mutual trust relationship (e.g., a two-way trust) is established, the present disclosure enables users of the tenant in the private cloud 108 to initiate and use application services of the private cloud 108, in addition to the application services of the public cloud 106. In aspects, establishing the mutual trust relationship between the public cloud 106 and the private cloud 108 by mapping may be referred to as on-boarding of the private cloud 108.

As will be appreciated, the various methods, devices, applications, features, etc., described with respect to FIG. 1 are not intended to limit the system 100 to being performed by the particular applications and features described. Accordingly, additional controller configurations may be used to practice the methods and systems herein and/or features and applications described may be excluded without departing from the methods and systems disclosed herein.

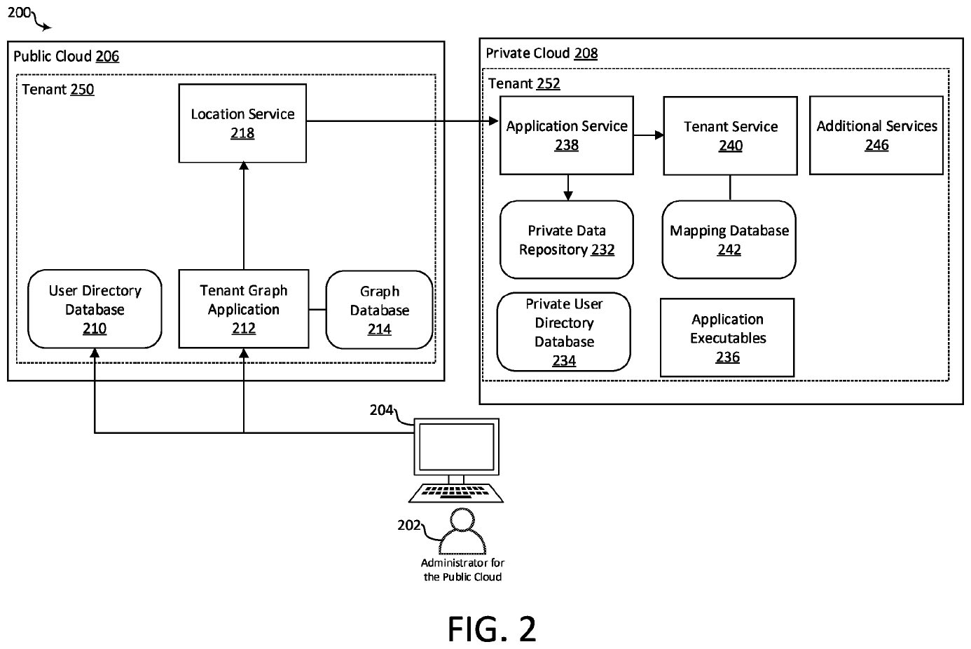

FIG. 2 illustrates an overview of an example system of using clouds for secure cross-cloud resource access in accordance with aspects of the present disclosure. A system 200 includes a client device 204, public cloud 206, and private cloud 208. The client device 204 may be used by an administrator 202 for the public cloud 206. The public cloud 206 includes user directory database 210, tenant graph application 212, graph database 214, and a location service 218. The private cloud 208 includes private data repository 232, private user directory database 234, application executables 236, application service 238, tenant service 240, additional services 246, and mapping database 242.

After the onboarding of the private cloud 208 as detailed in FIG. 1, the administrator 202 of the public cloud 206 is able to log in and execute operations of an application service associated with a tenant in the private cloud 208. The application service 238 in the private cloud 208 identifies a tenant service 240 associated with the tenant in the private cloud, based on the tenant mapping. The tenant service 240 then operates on behalf of the mapped tenant in the public cloud.

In examples, the user directory database 210 stores and maintains user identities of users in the public cloud 206 for authentication. The tenant graph application 212 maintains graph data associated with tenants stored in other clouds in the graph database 214. Based on the graph data, the tenant graph application 212 in the public cloud 206 connects with application services associated with a requested tenant in another cloud (e.g., the private cloud 208). The location service 218 connects with an application service 238 in the private cloud 208 based on given location information associated with a tenant in the private cloud 208.

The private cloud 208 includes a tenant 252 that has been mapped to a tenant 250 in the public cloud 206 based on the onboarding of the private cloud 208 as detailed in FIG. 1. The private cloud 208 includes private data repository 232, private user directory database 234, application executables 236, application service 238, tenant service 240, mapping database 242, and additional services 246.

The application service 238 receives a request for initiating an application service in a tenant in the private cloud 208. The request includes information associated with the tenant to be connected with and application service(s) to be initiated in the private cloud 208. The application service 238 connects with the tenant service 240 to initiate an application service as requested by the request. The tenant service 240 has access to the mapping database 242 for confirming the mapping between the tenant and a tenant in the public cloud 206.

After authenticating the administrator 202 for the public cloud 206, the tenant graph application 212 accesses the graph database 214 and retrieves location information associated with a tenant in the private cloud 208. The tenant graph application 212 requests the location service 218 to connect with application service 238 in the private cloud 208. The location service 218 performs a primary authentication and authorization associated with the tenant in the public cloud 206. Upon successful authentication and authorization, the location service redirects the request to the application service 238 to perform operations as requested by the administrator 202 for the public cloud 206 using the client device 204.

The application service 238 receives the request from the location service 218 to start an application service in a tenant that is mapped in the private cloud 208. The application service 238 retrieves information associated with the mapped tenant in the private cloud 208 by accessing the mapping database 242 through the tenant service 240. The application service 238 further enables access to the private data repository 232 by using an identity of the tenant in the private cloud 208.

As will be appreciated, the various methods, devices, applications, features, etc., described with respect to FIG. 2 are not intended to limit the system 200 to being performed by the particular applications and features described. Accordingly, additional controller configurations may be used to practice the methods and systems herein and/or features and applications described may be excluded without departing from the methods and systems disclosed herein.

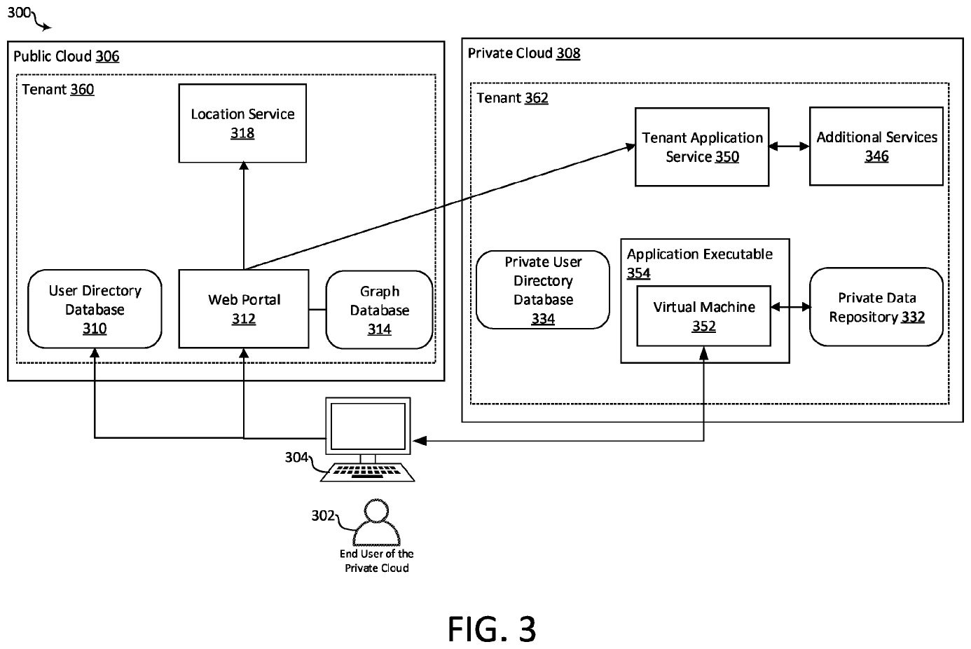

FIG. 3 illustrates an overview of an example system of an end user accessing secure cross-cloud resources in accordance with aspects of the present disclosure. A system 300 includes a client device 304, public cloud 306, and private cloud 308. The client device 204 is used by end user 302 of private cloud 308. In examples, the end user 302 is an end user in a cross-cloud scenario where the end user also uses a user identity associated with a public cloud. In such examples, the end user 302 of the private cloud 308 securely accesses, through the public cloud 306, resources (e.g., application services and data resources) that are securely stored in a private cloud with more restricted access controls.

The user directory database 310 stores and maintains identities and credentials of users of the public cloud 206. The web portal 312 provides a portal function to the client device 304 and enables the end user 302 of the private cloud 308 to access application services and data resources of the private cloud 308 through the public cloud 206. The web portal 312 accesses the graph database 314, which stores at least one relationship between tenant 360 in the public cloud 206 and tenant 362 in the private cloud 208 as graph data. The location service 318 identifies locations of tenants in other clouds.

The private cloud 308 includes private data repository 332, private user directory database 334, and application executable 354. The application executable 354 includes virtual machine 352 for executing application services including a virtual desktop.

In examples, the client device 304 receives an identity and credentials of an end user 302 of the private cloud 308. The client device 304 (e.g., via an executable of a browser application executing in the client device 304) communicates with the web portal 312 of the public cloud 306 for logging in the end user. The client device 304 requests launching a virtual desktop associated with a tenant in the private cloud 308. The client device 304 retrieves an authentication token of the end user 302 in the public cloud 306. In particular, the end user 302 of a tenant of a private cloud uses a user identity associated with the public cloud 306 first. The end user 302 then logs into the private cloud 308 through the web portal 312 using another user identity associated with the private cloud 308 for accessing the resources (e.g., both application services and data resources) that are securely stored in a private cloud with more restricted access controls.

The client device 304 transmits a request for initiating and operating the virtual desktop to the web portal 312. The web portal 312 retrieves credential data of the user identity associated with the public cloud 306 from the user directory database and an identity of the tenant in the private cloud 308 from the graph database 314. The web portal 312 further retrieves location information of the tenant in the private cloud 308 from the location service 318. The web portal 312 requests the tenant application service 350 of the private cloud 308 to initiate the virtual desktop using a virtual machine executing the application executable 354.

The tenant application service 350 in the private cloud 308 retrieves information associated with the virtual machine 352 with the virtual desktop. In aspects, the tenant application service 350 initiates the application executable 354 that executes the virtual machine 352 where the virtual desktop runs. The tenant application service 350 may initiate additional services 346 when the request from the web portal 312 includes initiating the additional services 346.

The application executable 354 executes a virtual machine 352 that may further execute the virtual desktop. The application executable 354 enables the virtual desktop to access the private data repository 232 using credentials of a user identity of the end user 302 of the private cloud 308.

As will be appreciated, the various methods, devices, applications, features, etc., described with respect to FIG. 3 are not intended to limit the system 300 to being performed by the particular applications and features described. Accordingly, additional controller configurations may be used to practice the methods and systems herein and/or features and applications described may be excluded without departing from the methods and systems disclosed herein.

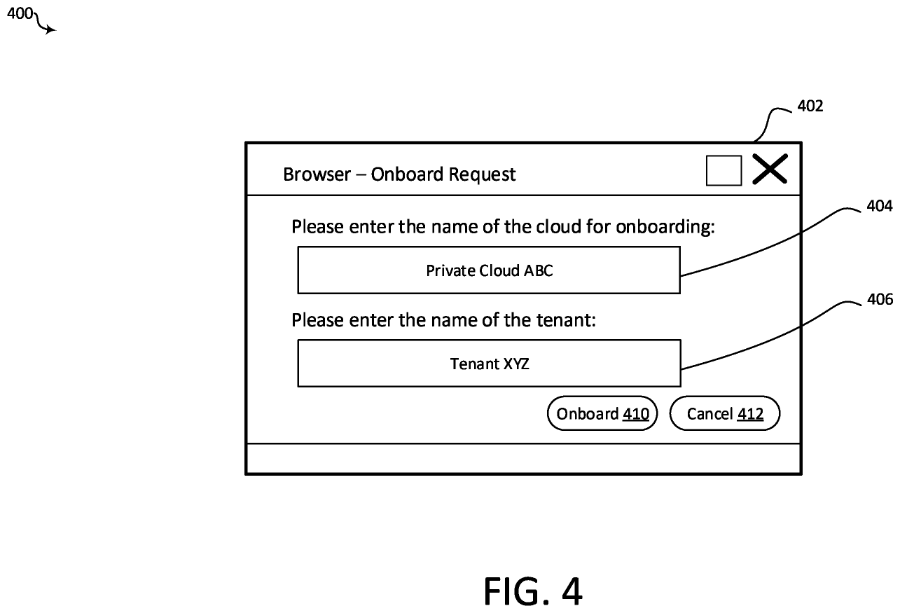

FIG. 4 illustrates an example graphical user interface in accordance with aspects of the present disclosure. The graphical user interface 400 includes a window 402 that displays an on-boarding request window used to initiate an onboarding or mapping of a tenant in another cloud. The window 402 includes an input and/or selection field 404 for specifying a name of another cloud. The window 402 further includes another input and/or selection field 406 for specifying a name of a tenant in the cloud for the onboarding. In examples, the disclosure displays the window 402 on a client device (e.g., the client device 104 as shown in FIG. 1) after the administrator provides user identities associated with both the administrator of the public cloud and the administrator for the private cloud (e.g., the administrator 102A for the public cloud 306 and the administrator 102B for the private cloud 308 as shown in FIG. 1). The window 402 further includes selection buttons of “Onboard” 410 button and “Cancel” 412 button. Receiving a selection of the “Onboard” 410 button triggers the client device to transmit a request to the tenant graph to proceed with the onboarding process, as detailed in FIG. 1. In other embodiments, other information may be requested or received to enable the onboarding.

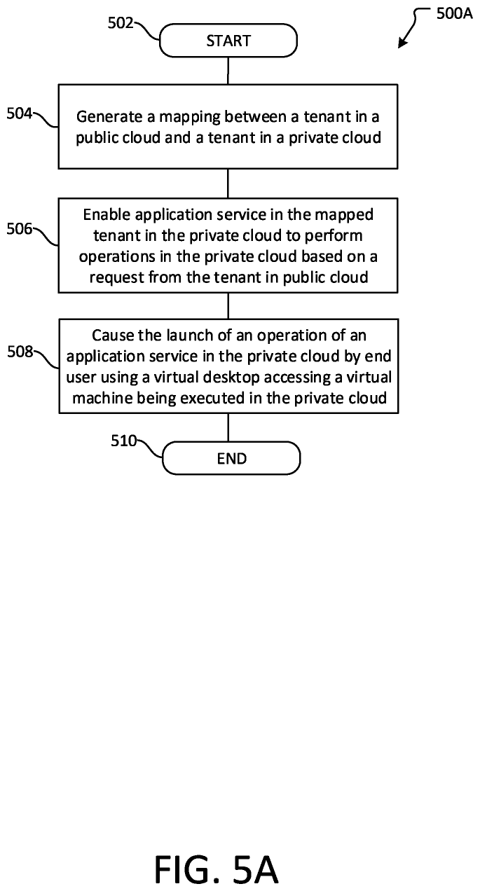

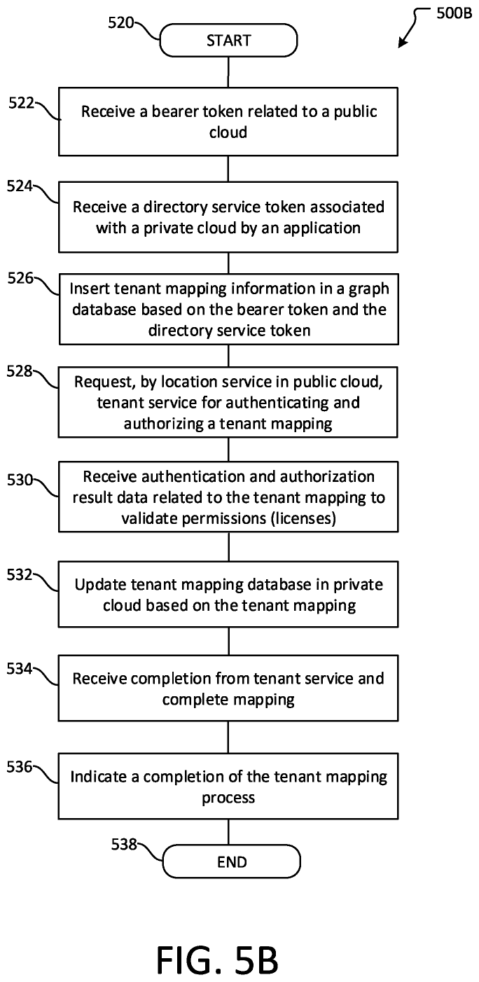

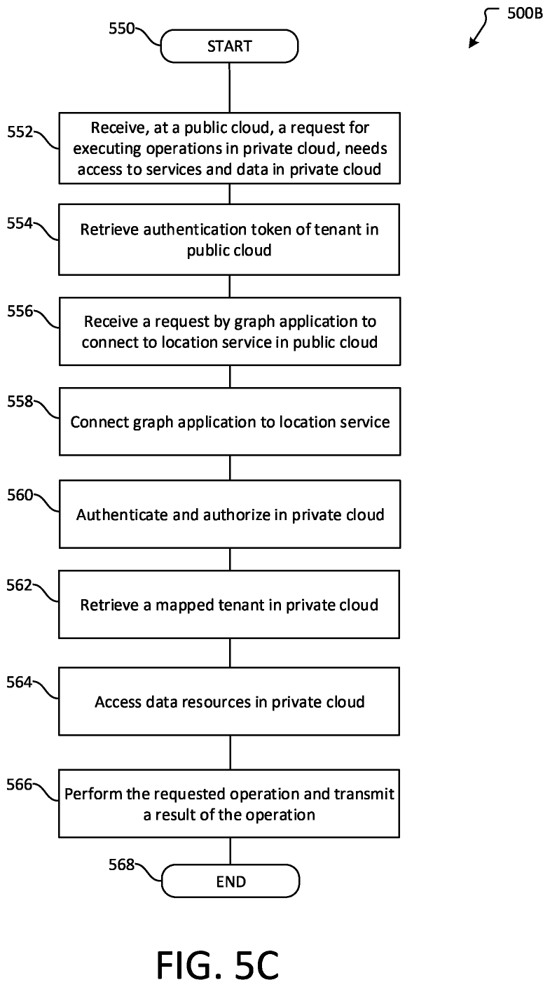

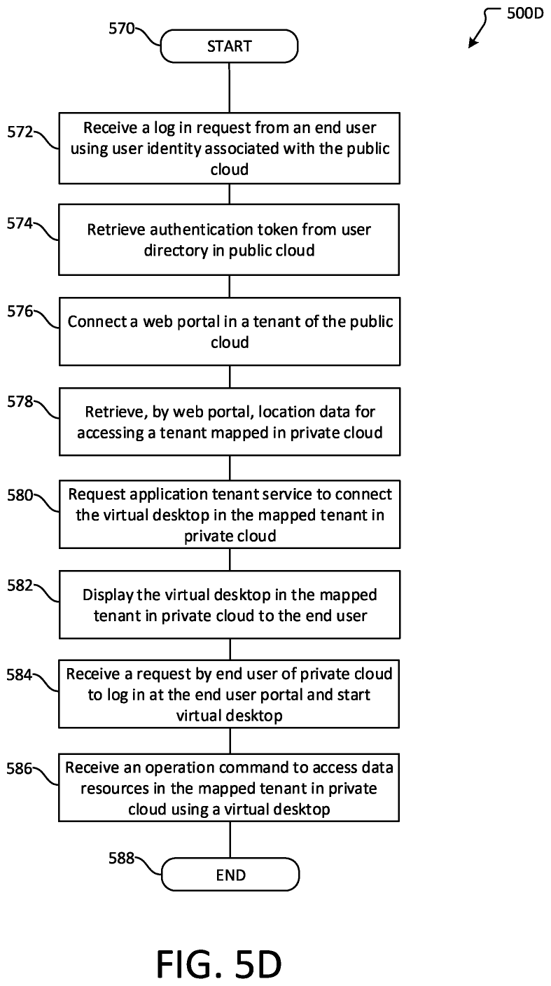

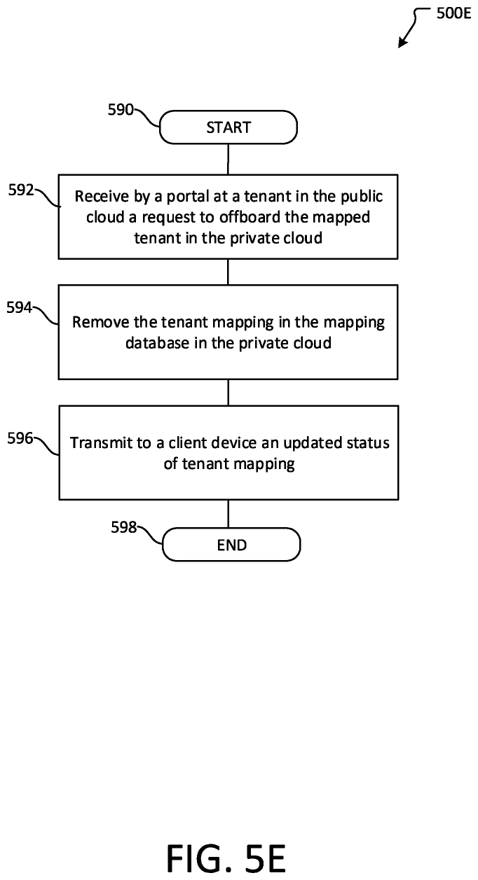

FIG. 5A illustrates an example of methods of establishing a cross-cloud mapping and accessing resources in a private cloud for a secure cross-cloud resource access in accordance with aspects of the present disclosure. A general order of the onboarding operations for the method 500A is shown in FIG. 5A. Generally, the method 500A begins with start operation 502. The method 500A may include more or fewer steps or may arrange the order of the steps differently than those shown in FIG. 5A. The method 500A can be executed as a set of computer-executable instructions executed by a computer system and encoded or stored on a computer readable medium. Further, the method 500A can be performed by gates or circuits associated with a processor, an ASIC, an FPGA, a SOC or other hardware device. Hereinafter, the method 500A shall be explained with reference to the systems, components, devices, modules, software, data structures, data characteristic representations, signaling diagrams, methods, etc., described in conjunction with FIGS. 1, 2, 3, 4, 5B-5E, 6, and 7A-B.

Following start operation 502, the method 500A begins with generate operation 504, in which a mapping between a tenant in a public cloud and another tenant in a private cloud is generated as an onboarding process. Detailed processes of the onboarding including establishing the mapping based on user identities of the administrators for the public cloud and the private cloud as detailed in FIG. 1.

At enable operation 506, an application service in the mapped tenant in the private cloud is enabled to perform operations in the private cloud. Once enabled, the application service in the private cloud may initiate an application executable in the tenant in the private cloud in response to a request from the tenant in the public cloud. In examples, the enable operation 506 includes receiving a user identity of the administrator of the public cloud to use the established cross-domain mapping, as detailed in FIG. 2.

At launch operation 508, the application service in the private cloud is launched based a request from the end user of the private cloud. The application service executes an application executable that executes an instance of a virtual machine that executes a virtual desktop. The virtual desktop enables the end user to operate applications executed in the private cloud and accessing data resources stored in the private cloud, as detailed in FIG. 3. The method 500A ends with the end operation 510.

As should be appreciated, operations 502-510 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 5B illustrates an example of methods of establishing a cross-cloud mapping for secure cross-cloud resource access (e.g., onboarding) in accordance with aspects of the present disclosure. A general order of the operations for the method 500B for enabling usage of an application service across clouds is shown in FIG. 5B. Generally, the method 500B begins with start operation 520. The method 500B may include more or fewer steps or may arrange the order of the steps differently than those shown in FIG. 5B. The method 500B can be executed as a set of computer-executable instructions executed by a computer system and encoded or stored on a computer readable medium. Further, the method 500B can be performed by gates or circuits associated with a processor, an ASIC, an FPGA, a SOC or other hardware device. Hereinafter, the method 500B shall be explained with reference to the systems, components, devices, modules, software, data structures, data characteristic representations, signaling diagrams, methods, etc., described in conjunction with FIGS. 1, 2, 3, 4, 5A, 5C-5E, 6, and 7A-B.

Following start operation 520, the method 500B begins with receive a bearer token operation 522, which receives a bearer token associated with the public cloud. The bearer token is based on a user identity of an administrator for the public cloud interactively received by a client device.

At receive a directory service token operation 524, a directory service token associated with the private cloud is received. The directory service token is based on a user identity of an administrator for the private cloud interactively received by the client device.

At insert operation 526, a tenant mapping is inserted in a graph database in the public cloud by a graph application. The tenant mapping is based on the bearer token and the directory service token. In aspects, the insert operation 526 includes calling an application programming interface (API) to add a cross-cloud organization mapping in a graph database based on a combined credentials of the administrator for the public cloud and the administrator for the private cloud.

At request operation 528, a request is made by a location service in the public cloud to a tenant service in the private cloud for authenticating and authorizing the cross-cloud tenant mapping. The authentication includes validating both the bearer token of the public cloud and the directory service token of the private cloud.

At authenticate and authorize operation 530, the cross-cloud mapping is authenticated and authorized. The authentication may further include determining whether the requesting tenant in the public cloud has a license or permission to execute the application service. The authorization may include checking whether the both tokens are valid, and checking whether identifiers of the application services for both tokens are valid. The authorization may further include whether roles of the administrators of both the public cloud and the private clouds satisfy a set of predetermined conditions associated with authorized roles in accessing and using resources in the private cloud.

At update operation 532, a mapping database in the private cloud is updated based on the cross-cloud tenant mapping according to the successful authentication and authorization. The cross-cloud mapping indicates a two-way trust between the requesting tenant in the public cloud and the tenant in the private tenant.

At receive operation 534, a successful completion status of the cross-cloud tenant mapping is received from the tenant service in the private cloud by the location service in the public cloud. When the authenticate and authorize operation 530 results in a failure in either or both of the authentication and authorization, the receive operation 534 receives an error status, failing to establish the cross-cloud mapping.

At indicate operation 534, the completion status of the cross-cloud tenant mapping process is indicated on the client device. In examples, the client device displays the completion status on its display. The method 500B ends with the end operation 538.

As should be appreciated, operations 520-538 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 5C illustrates an example of methods of using a cross-cloud mapping of tenants for accessing secure cross-cloud resources in accordance with aspects of the present disclosure. A general order of the operations for the method 500C for enabling usage of an application service across clouds is shown in FIG. 5C. Generally, the method 500C begins with start operation 550. The method 500C may include more or fewer steps or may arrange the order of the steps differently than those shown in FIG. 5C. The method 500C can be executed as a set of computer-executable instructions executed by a computer system and encoded or stored on a computer readable medium. Further, the method 500C can be performed by gates or circuits associated with a processor, an ASIC, an FPGA, a SOC or other hardware device. Hereinafter, the method 500C shall be explained with reference to the systems, components, devices, modules, software, data structures, data characteristic representations, signaling diagrams, methods, etc., described in conjunction with FIGS. 1, 2, 3, 4, 5A-B, 5D-5E, 6, and 7A-B.

Following start operation 550, the method 500C begins with receive operation 552, in which a request for executing operations in the private cloud is received by the public cloud. In particular, the request includes executing operations using an application service in a tenant in the private cloud, which cross-mapping has been established as detailed in FIG. 5B. In aspects, the request for the operations is received from a client device used by the administrator of the public cloud using a user identity of the administrator of the public cloud.

At retrieve operation 554, an authentication token of the tenant in the public cloud is retrieved from a user directory database in the public cloud. The retrieve operation 554 retrieves the token based on the user identify of the administrator for the public cloud.

At receive operation 556, a request for a tenant graph application (e.g., the tenant graph application 112 as shown in FIG. 1) to connect to a location service is received in the public cloud. In aspects, the receive operation 556 receives the request from the client device used by the administrator of the public cloud.

At connect operation 558, the graph application connects with the location service. In aspects, the connect operation 558 includes the tenant graph application in the public cloud calling a location service application programming interface (API) to connect to the location service in the public cloud.

At authenticate and authorize the public cloud tenant operation 560, the requested access to the private cloud from the public cloud is authenticated and authorized by the location service in the public cloud. In aspects, the location service authenticates and authorizes the requesting tenant in the public cloud based on a user identity the administrator for the public cloud. Upon a successful authentication and authorization, the location service in the public cloud redirects the request for access to an application service in the private cloud for further authentication and authorization.

At retrieve operation 562, a tenant in the private cloud, which is mapped with the requesting tenant in the public cloud, is retrieved from the mapping database as a cross-cloud mapped tenant in the private cloud. The mapping database in the private cloud stores and maintains data that map a tenant in the public cloud and a tenant in the private cloud as a cross-tenant mapping.

At access operation 564, data resources in the private cloud are accessed by the application service in the private cloud. The access to the data resources in the private cloud is based on an identity of the mapped tenant of the private cloud.

At perform operation 566, the requested operation for accessing data resources in the private cloud is performed. A result of the operation is transmitted to the public cloud in response to the request for performing the operations. The response indicates whether the operation was successful. The method 500C ends with an end operation 568.

As should be appreciated, operations 550-568 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 5D illustrates an example of method for an end user accessing secure cross-cloud resources in accordance with aspects of the present disclosure. A general order of the operations for the method 500D for an end user operating an application and accessing resources across clouds is shown in FIG. 5D. Generally, the method 500D begins with start operation 570. The method 500D may include more or fewer steps or may arrange the order of the steps differently than those shown in FIG. 5D. The method 500D can be executed as a set of computer-executable instructions executed by a computer system and encoded or stored on a computer readable medium. Further, the method 500D can be performed by gates or circuits associated with a processor, an ASIC, an FPGA, a SOC or other hardware device. Hereinafter, the method 500D shall be explained with reference to the systems, components, devices, modules, software, data structures, data characteristic representations, signaling diagrams, methods, etc., described in conjunction with FIGS. 1, 2, 3, 4, 5A-5C, 5E, 6, and 7A-B.

Following start operation 570, the method 500D begins with receive operation 572, in which a request for starting a virtual desktop to access the private cloud is received. The request is interactively entered in a computing device by an end user of a private cloud. A user identity is of the end user is also stored in a public cloud to log in to the public cloud. The public cloud uses the user identity of the end user stored in the public cloud to redirect a request to start a virtual desktop in the private cloud. The end user of a tenant of a private cloud uses a user identity associated with the public cloud to start using the virtual desktop while using a user identity associated with the private cloud to access data resources that are securely stored in the private cloud.

At retrieve operation 574, an authentication token is retrieved from a user directory in the public cloud. The authentication token is based on credentials of the end user whose user identities are managed in the public cloud.

At connect operation 576, the client device and a web portal in the tenant of the public cloud is connected. In examples, the client device displays an entry screen of the web portal.

At retrieve location data operation 578, location data is retrieved for accessing a tenant mapped in the private cloud. In examples, the location data include a name of tenant, a name of the private cloud, an address of the tenant, and the like.

At request operation 580, a connection of a virtual desktop in the cross-cloud mapped tenant in the private cloud to the public cloud is requested by the web portal.

At display operation 582, a virtual desktop, which runs on a virtual machine that is executed in the private cloud, is displayed on the client device. The virtual desktop enables the end user use service applications that are executed in in the mapped tenant of the private cloud through the public cloud.

At receiving a request to log into the private cloud operation 584, a login request to login the end user to the private cloud is received. The end user enters user credentials for accessing the private cloud and use data resources that are stored in the private cloud.

At receive operation commands operation 586, an operation command is received for accessing data resources in the mapped tenant in the private cloud. In aspects the end user operates the service applications running in the virtual desktop and accesses data resources stored in the private cloud. The method 500D ends with an end operation 588.

As should be appreciated, operations 570-588 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

FIG. 5E illustrates an example of methods of releasing the established mapping (e.g., offboarding the mapped tenant) from secure cross-cloud resource access in accordance with aspects of the present disclosure. A general order of the operations for the method 500E for offboarding a tenant is shown in FIG. 5E. Generally, the method 500E begins with start operation 590. The method 500E may include more or fewer steps or may arrange the order of the steps differently than those shown in FIG. 5E. The method 500E can be executed as a set of computer-executable instructions executed by a computer system and encoded or stored on a computer readable medium. Further, the method 500E can be performed by gates or circuits associated with a processor, an ASIC, an FPGA, a SOC or other hardware device. Hereinafter, the method 500E shall be explained with reference to the systems, components, devices, modules, software, data structures, data characteristic representations, signaling diagrams, methods, etc., described in conjunction with FIGS. 1, 2, 3, 4, 5A-5D, 6, and 7A-B.

Following start operation 590, the method 500E begins with receive operation 592, in which a request to offboard a mapped tenant. In aspects, the mapped tenant is a cross-cloud mapped tenant in the private cloud. The request may be received via a web portal in the public cloud from the client device. The request may be received from the administrator for the public cloud, for example.

At remove operation 594, the tenant mapping is removed from the mapping database in the private cloud. Once the tenant mapping is removed, the end user of the private cloud can no longer use a virtual desktop accessing the virtual machine of a tenant application in the private cloud through the public cloud.

At transmit operation 596, an updated status of cross-cloud tenant mapping after removing the tenant mapping is transmitted to the client device. The updated status is transmitted to the client device in response to receiving the request to off-board the mapped tenant. The method 500E ends with end operation 598.

As should be appreciated, operations 590-598 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

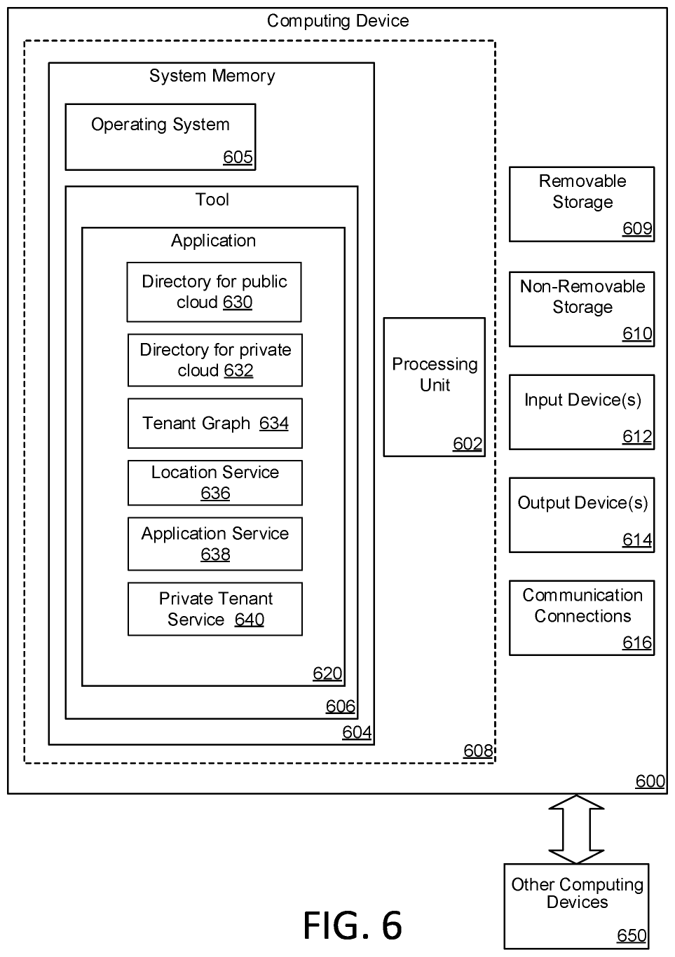

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program tools 606 suitable for performing the various aspects disclosed herein such. The operating system 605, for example, may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program tools and data files may be stored in the system memory 604. While executing on the at least one processing unit 602, the program tools 606 (e.g., an application 620) may perform processes including, but not limited to, the aspects, as described herein. The application 620 includes directory for public cloud 630, directory for private cloud 632, tenant graph 634, location service 636, application service 638, and private tenant service 640 as described in more details in FIG. 1. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 600 may also have one or more input device(s) 612, such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of the communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 600. Any such computer storage media may be part of the computing device 600. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

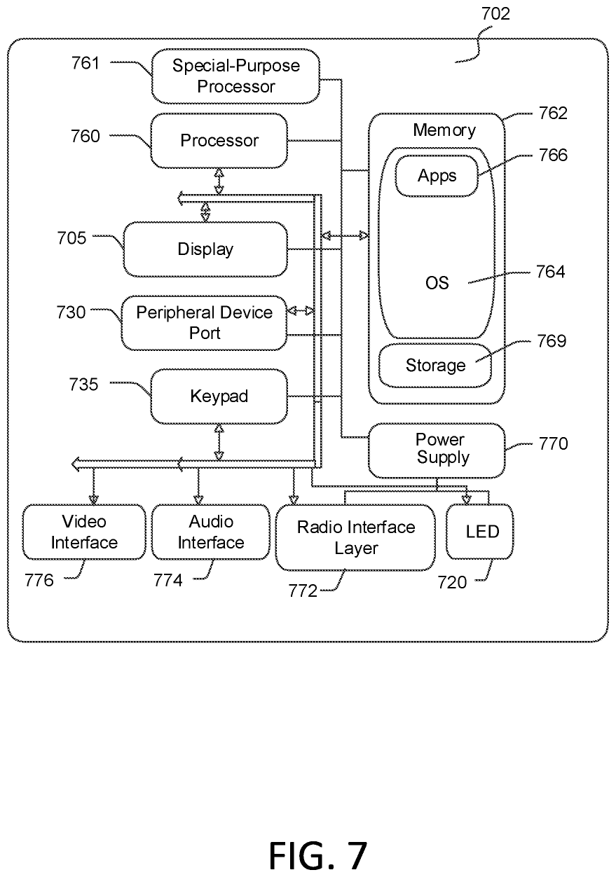

FIG. 7 is a block diagram illustrating the architecture of one aspect of computing device (e.g., the client device 104), a server (e.g., the public cloud 106 and the private cloud 108 as shown in FIG. 1), and the like. The system 702 can be integrated as a computing device.

One or more application programs 766 may be loaded into the memory 762 and run on or in association with the operating system 764. Examples of the application programs include phone dialer programs, e-mail programs, information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage 769 synchronized with corresponding information stored at the host computer. As should be appreciated, other applications may be loaded into the memory 762 and run on the computing device described herein.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 (e.g., LED) may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of devices connected to a peripheral device port 730 to record still images, video stream, and the like.

The computing device implementing the system 702 may have additional features or functionality. For example, the computing device may also include additional data storage devices (removable and/or non-removable) such as, magnetic disks, optical disks, or tape. Such additional storage is illustrated in FIG. 7 by the non-volatile storage area 768.

Data/information generated or captured by the computing device and stored via the system 702 may be stored locally on the computing device, as described above, or the data may be stored on any number of storage media that may be accessed by the device via the radio interface layer 772 or via a wired connection between the computing device and a separate computing device associated with the computing device, for example, a server computer in a distributed computing network, such as the Internet. As should be appreciated such data/information may be accessed via the computing device via the radio interface layer 772 or via a distributed computing network. Similarly, such data/information may be readily transferred between computing devices for storage and use according to well-known data/information transfer and storage means, including electronic mail and collaborative data/information sharing systems.

The present disclosure relates to systems and methods of creating a cross-cloud relationship. A method comprises receiving, by a first cloud, a request to onboard a second cloud to create a cross-cloud relationship, wherein the request includes a first token associated with a first tenant in the first cloud, and a second token associated with a second tenant in the second cloud, wherein the second tenant is distinct from the first tenant, and the second cloud is distinct from the first cloud; transmitting an authentication request for authenticating the cross-cloud relationship to the second tenant, wherein the request includes the first token, the second token, and tenant information associated with the first tenant; receiving authentication result data from the second tenant; transmitting an authorization request for authorizing the cross-cloud relationship to the second tenant; receiving authorization result data from the second tenant; creating a mapping entry between the first tenant and the second tenant; and storing the mapping entry in a graph database in the first cloud. The first token comprises a first tenant identifier associated with the first tenant in the first cloud, a first application identifier, and a role setting associated with the first user, and wherein the second token the second token comprises a tenant identifier associated with the second tenant in the second cloud, a second application identifier, and a role setting associated with the second use. The authentication result data from the second tenant includes a result of authenticating the second user as an administrator associated with the second tenant in the second cloud. The first cloud includes a public cloud, and the second cloud includes a private cloud. The authentication result data comprises a result of validating the first token and the second token, and a result of validating an authentication of the first tenant in the first cloud for launching operation of an application. The mapping entry represents the cross-cloud relationship between the first tenant in a public cloud and the second tenant in a private cloud. The authorization result data include a result of validating the first token and the second token, a result of validating an identifier associated with an application service to be executed in the second tenant in the second cloud, and a result of validating roles associated with the first tenant in the first cloud and the second tenant in the second cloud. The first token is based on first credential data and the second token is based second credential data, and wherein the first credential data and the second credential data are distinct.

Another aspect of the technology relates to a system for creating a cross-cloud relationship between tenants for secure cross-cloud access. The system comprises a processor configured to execute a method comprising receiving, by a first cloud, a request to onboard a second cloud wherein the request includes a first token associated with a first tenant in the first cloud, and a second token associated with a second tenant in the second cloud, wherein the second tenant is distinct from the first tenant, and the second cloud is distinct from the first cloud; transmitting an authentication request for authenticating the cross-cloud relationship to the second tenant, wherein the request includes the first token, the second token, and tenant information associated with the first tenant; receiving authentication result data from the second tenant; transmitting an authorization request for authorizing the cross-cloud relationship to the second tenant, wherein the request includes the first token, the second token, and tenant information associated with the first tenant; receiving authorization result data from the second tenant; create a mapping entry between the first tenant and the second tenant; and storing the mapping entry in a graph database in the first cloud. The first token comprises a first tenant identifier associated with the first tenant in the first cloud, a first application identifier, and a role setting associated with the first user; and wherein the second token comprises a tenant identifier associated with the second tenant in the second cloud, a second application identifier, and a role setting associated with the second use. The authorization result data from the second tenant include a result of authenticating the second user as an administrator associated with the second tenant in the second cloud. The first cloud includes a public cloud, and the second cloud includes a private cloud. The first credential data and the second credential data are distinct. The processor is further configured to execute a method comprising causing a launch of operating a virtual machine in the second tenant in the second cloud, wherein the virtual machine executes an application in a virtual desktop; and causing display of the virtual desktop associated with the virtual machine for interactively operating the application and accessing data resources in the second tenant in the second cloud. The mapping represents a two-way trust between the first tenant in a public cloud and the second tenant in a private cloud.

In still further aspects, the technology relates to a method for creating cross-cloud relationship between a first tenant in a first cloud and a second tenant in a second cloud for accessing the second tenant in the second cloud from the first tenant in the first tenant. The method comprises receiving, by the second tenant in the second cloud, a request for a login by a user; retrieving a token associated with the user in the second tenant of the second cloud; transmitting the token to the first tenant in the first cloud; receiving an authentication request from the first tenant in the first cloud; performing authentication of the cross-cloud relationship; transmitting authentication result data to the first tenant in the first cloud; receiving an authorization request from the first tenant in the first cloud; performing authorization of the cross-cloud relationship; and transmitting authorization result data to the first tenant in the first cloud. The token includes a tenant identifier, an application identifier, and a role setting associated with an administrator account. The first cloud includes a public cloud, and the second cloud includes a private cloud. The method further comprises launching operation of a virtual desktop in a virtual machine in the second tenant in the second cloud receiving a request for login into the virtual desktop; and displaying the virtual desktop associated with the virtual machine for interactively operating an application and accessing data resources in the second tenant in the second cloud. The mapping entry represents a cross-cloud relationship between the first tenant in a public cloud and the second tenant in a private cloud.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method of creating a cross-cloud relationship comprising:
receiving, by a first cloud, a request to onboard a second cloud to create a cross-cloud relationship, wherein the request includes a first token associated with a first tenant in the first cloud, and a second token associated with a second tenant in the second cloud, wherein the second tenant is distinct from the first tenant, and the second cloud is distinct from the first cloud;
transmitting an authentication request for authenticating the cross-cloud relationship to the second tenant, wherein the request includes the first token, the second token, and tenant information associated with the first tenant;
receiving authentication result data from the second tenant;
transmitting an authorization request for authorizing the cross-cloud relationship to the second tenant;
receiving authorization result data from the second tenant;
creating a mapping entry between the first tenant and the second tenant; and
storing the mapping entry in a graph database in the first cloud.

2. The method of claim 1, wherein the first token comprises:
a first tenant identifier associated with the first tenant in the first cloud,
a first application identifier, and
a role setting associated with the first user, and
wherein the second token the second token comprises:
a tenant identifier associated with the second tenant in the second cloud,
a second application identifier, and
a role setting associated with the second use.

3. The method of claim 1, wherein
the authentication result data from the second tenant includes a result of authenticating the second user as an administrator associated with the second tenant in the second cloud.

4. The method of claim 1, wherein the first cloud includes a public cloud, and the second cloud includes a private cloud.

5. The method of claim 1, wherein the authentication result data comprises:
a result of validating the first token and the second token, and
a result of validating an authentication of the first tenant in the first cloud for launching operation of an application.

6. The method of claim 1, wherein the mapping entry represents the cross-cloud relationship between the first tenant in a public cloud and the second tenant in a private cloud.

7. The method of claim 1, wherein the authorization result data include:
a result of validating the first token and the second token,
a result of validating an identifier associated with an application service to be executed in the second tenant in the second cloud, and
a result of validating roles associated with the first tenant in the first cloud and the second tenant in the second cloud.

8. The method of claim 2, wherein the first token is based on first credential data and the second token is based second credential data, and wherein the first credential data and the second credential data are distinct.

9. A system for creating a cross-cloud relationship between tenants for secure cross-cloud access, comprising:
a processor configured to execute a method comprising:
receiving, by a first cloud, a request to onboard a second cloud wherein the request includes a first token associated with a first tenant in the first cloud, and a second token associated with a second tenant in the second cloud, wherein the second tenant is distinct from the first tenant, and the second cloud is distinct from the first cloud;
transmitting an authentication request for authenticating the cross-cloud relationship to the second tenant, wherein the request includes the first token, the second token, and tenant information associated with the first tenant;
receiving authentication result data from the second tenant;
transmitting an authorization request for authorizing the cross-cloud relationship to the second tenant, wherein the request includes the first token, the second token, and tenant information associated with the first tenant;
receiving authorization result data from the second tenant;
create a mapping entry between the first tenant and the second tenant; and
storing the mapping entry in a graph database in the first cloud.

10. The system of claim 9 wherein the first token comprises:
a first tenant identifier associated with the first tenant in the first cloud,
a first application identifier, and
a role setting associated with the first user; and
wherein the second token comprises:
a tenant identifier associated with the second tenant in the second cloud,
a second application identifier, and
a role setting associated with the second use.

11. The system of claim 9, wherein
the authorization result data from the second tenant include a result of authenticating the second user as an administrator associated with the second tenant in the second cloud.

12. The system of claim 9, wherein the first cloud includes a public cloud, and the second cloud includes a private cloud.

13. The system of claim 9, wherein the first credential data and the second credential data are distinct.

14. The system of claim 9, the processor further configured to execute a method comprising:
causing a launch of operating a virtual machine in the second tenant in the second cloud, wherein the virtual machine executes an application in a virtual desktop; and
causing display of the virtual desktop associated with the virtual machine for interactively operating the application and accessing data resources in the second tenant in the second cloud.

15. The system of claim 9, wherein the mapping represents a two-way trust between the first tenant in a public cloud and the second tenant in a private cloud.

16. A method for creating a cross-cloud relationship between a first tenant in a first cloud and a second tenant in a second cloud for accessing the second tenant in the second cloud from the first tenant in the first cloud, comprising:
receiving, by the second tenant in the second cloud, a request for a login by a user;
retrieving a token associated with the user in the second tenant of the second cloud;
transmitting the token to the first tenant in the first cloud;
receiving an authentication request from the first tenant in the first cloud;
performing authentication of the cross-cloud relationship;
transmitting authentication result data to the first tenant in the first cloud;
receiving an authorization request from the first tenant in the first cloud;
performing authorization of the cross-cloud relationship; and
transmitting authorization result data to the first tenant in the first cloud.

17. The method of claim 16, wherein the token includes:
a tenant identifier,
an application identifier, and
a role setting associated with an administrator account.

18. The method of claim 16, wherein the first cloud includes a public cloud, and the second cloud includes a private cloud.

19. The method of claim 16, further comprising:
launching operation of a virtual desktop in a virtual machine in the second tenant in the second cloud
receiving a request for login into the virtual desktop; and
displaying the virtual desktop associated with the virtual machine for interactively operating an application and accessing data resources in the second tenant in the second cloud.

20. The method of claim 16, wherein the mapping entry represents a cross-cloud relationship between the first tenant in a public cloud and the second tenant in a private cloud.
